(19) United States
(12) Patent Application Publication
(10) Pub. No.: US 2026/0220024 A1
(43) Pub. Date: Jul. 30, 2026

(54) SYSTEMS AND METHODS FOR TESTING, CERTIFYING, AND RECERTIFYING SAFETY MODELS

(71) Applicant: Reynolds & Moore, LLC, Keller, TX (US)

(72) Inventor: Samuel Erik Reynolds, Keller, TX (US)

(21) Appl. No.: 19/041,349

(22) Filed: Jan. 30, 2025

(51) Int. Cl. G06F 11/3604; G06F 11/3668; G06Q 30/018

(52) U.S. Cl. CPC G06F 11/3616; G06F 11/3688; G06F 11/3692; G06Q 30/018

(57) ABSTRACT

The present invention claims methods and systems for testing, certification, and recertification of safety models that cannot be explained or evaluated using traditional software assessment methodology due to the creation or development of software source code using machine learning or artificial intelligence models. Various embodiments of the invention implements fundamental changes to the traditional testing paradigm utilized in environments subject to safety and risk mitigation standards by providing systems and methods for the efficient virtual and physical testing of software developed by machine learning or artificial intelligence in safety testing, certification, and recertification processes and procedures.

### TECHNICAL FIELD

The present invention relates generally to systems and methods for testing, certifying, and recertifying safety models.

### BACKGROUND OF THE INVENTION

Certain technological developments such as the emergence of machine learning (ML) and artificial intelligence (AI) models and applications present system assessment challenges because current testing and certification systems are not designed to test or certify such technologies. For example, the testing and certification of software utilized in safety systems presently requires human evaluation and identification of logical flows and fault modes of the software. However, certain software (e.g., software created and modified by ML or AI) cannot be evaluated in this manner because the software does not exist in a format that lends itself to this type of assessment. In fact, with respect to software created and modified by ML or AI, the software code itself is unexplainable, and therefore, legitimate concerns have prevented the use of such software from being used in critical applications, such as those involving human safety. Due to the lack of effective testing and certification processes that can be applied to software applications that cannot be analyzed using traditional software assessment techniques, entire areas of the economy (e.g., safety systems) are deprived of the benefits associated with emerging technologies and related advances and efficiencies that could improve the lives of millions of people in ways not yet foreseen.

The current process of evaluating software for safety systems relies upon software that is explainable and understandable from a logical flow and fault mode perspective (e.g., how various inputs from the real-world environment will impact software logic outputs, especially as it relates to decision trees designed to protect humans in an otherwise hazardous environment). When first implemented, the software undergoes an evaluation process, which results in software certification for a particular application if the assessment of the software establishes that certain functional safety requirements are satisfied. The same process applies to changes or revisions made to software that was previously certified, although the certification time period for software revisions may be shorter (though not necessarily) if the revisions are limited in scope.

The certification process is founded on the ability of human certification authorities to evaluate the software. This safety assessment process follows a static paper or electronic document issuance process: software is submitted for approval and certification, once the software has been evaluated using traditional methods (e.g., analysis of logic flows and fault modes by human certification authority) and is determined to satisfy the safety threshold criteria, the certification authority issues a paper or electronic document to the software manufacturer/user certifying software as submitted for use in a particular application and environment. Revisions to previously-certified software use the same certification procedure pursuant to requirements set forth in ISO/IEC 17025:2017 and ISO/IEC 17065:2012. The antiquated nature of the certification process hinders the adoption of improved processes which can happen almost instantaneously using ML and AI, but which are subsequently burdened by the human certification component and the time necessary to complete the testing certification procedure, which is not adequate to evaluate unexplainable software. However, potential detrimental conditions that have arisen in the ML and AI context (e.g., hallucinations) must also be addressed in order to ensure that software safety characteristics are generally improving over time or at least continue to satisfy established safety standards.

### BRIEF SUMMARY OF THE INVENTION

The inventor has recognized that existing testing and certification processes that rely on the human evaluation of software structure, flows, decision trees, and coding distinctions prior to implementation is no longer a feasible option if emerging technologies are to be effectively implemented and that a paradigm shift from traditional software assessment (how the software works) to a performance software assessment (what the software does) is necessary. This fundamental change in how software is approved for use requires a sound testing regime to quantify the reliability of software paired with a dynamic certification and re-certification system that acknowledges and allows for the continuous software improvements and developments associated with emerging technologies in which the baseline functionality cannot be assessed using traditional assessment models. This invention allows for the elimination or modification of these traditional assessment models by replacing or modifying them with testing and certification methods that base certification on whether the software meets certain performance thresholds and correspondingly expediting the certification process by focusing on confirmed testing results rather than reviewed software design characteristics.

Although the emergence of ML and AI application to the software programming space, where the software is essentially unexplainable using traditional assessment methods, will be a factor in the adoption of the claimed invention, the invention is by no means limited to ML, AI, or future technological developments. When the invention is implemented, the structural content and logical operation of any software program or constituent component will no longer require the current human-resource-intensive analysis because the output of the software will be a fundamental benchmark used to certify the use of a software solution in a particular environment or for a particular application. Therefore, any software that satisfies the performance thresholds set forth by the appropriate regulatory body or certification authority can be tested and certified according to the invention regardless of how the software was created or compiled. The underlying testing model is based on the correlation between observed input data and the output data that results from the testing process, which can then be shown to satisfy functional safety requirements.

Embodiments of the invention combine the virtual testing of software that is not subject to traditional evaluation techniques due to the unexplainable nature of certain software applications (e.g., software created or revised by ML or AI) with a dynamic, yet reliable, certification (and recertification) process designed to ultimately enhance functional safety by harnessing the power of software that is capable of continuous improvement without eliminating the safeguards ensured by the human approval component of the certification procedure. However, in the present invention, the human assessment component can focus on evaluating the software output and operating parameters instead of evaluating distinct software design representations and logical flow characteristics. A preferred embodiment also includes a recertification system and method designed to expedite software updates or other changes resulting from ML or AI developments in the software. Embodiments of the present invention lend themselves to harness the power of software improvements continuously implemented by ML and AI models by establishing a recertification process that takes advantage of the concepts, data, and testing regimens developed, saved, and implemented in the immediately preceding certification procedure.

### BRIEF DESCRIPTION OF THE DRAWINGS

For a more complete understanding of the present invention, reference is now made to the following descriptions taken in conjunction with the accompanying drawings, in which:

FIG. 1 shows a system configured according to embodiments of the present invention to test, certify, and recertify software for safety.

FIG. 2 is a sequential flow chart setting forth a concept workflow according to certain embodiments of the present invention.

FIG. 3 is a sequential flow chart setting forth a virtual testing workflow according to certain embodiments of the present invention.

FIG. 4 is a sequential flow chart setting forth a physical testing workflow according to certain embodiments of the present invention.

FIG. 5 is a sequential flow chart setting forth an endpoint certification workflow according to certain embodiments of the present invention.

FIG. 6 is a sequential flow chart setting forth a recertification workflow according to certain embodiments of the present invention.

### DETAILED DESCRIPTION OF THE INVENTION

The specification begins with the inventor's recognition that certain software models that utilizes ML, AI, or other technology in some capacity is often neither transparent nor explainable and the compatibility of the models with functional safety requirements can be difficult or effectively impossible to demonstrate, which has created the unsolved need that this invention solves. In order to fully express the problem solved by the invention, it is necessary to understand the testing and certification process that currently exists with respect to software that can be evaluated and certified using traditional testing techniques, such as the analysis of logical flow and fault modes inherent in software code mapping that will allow humans to certify the use of such software to ensure that its application will satisfy the functional safety requirements associated with the particular application.

Because the software at issue does not lend itself to traditional evaluation techniques, testing of such software created or developed by ML, AI, or other software deemed non-transparent from an assessment perspective is sometimes referred to as “black box testing” in that the software can essentially only be evaluated by its inputs and its outputs as opposed to analyzing the software structure, coding, or logical flow. Virtual testing is generally characterized as the use of modeling, simulation, or other non-physical testing means to evaluate the characteristics or performance of a given system or application. Virtual test methodologies often use software-based algorithmic approaches to simulate real world testing conditions. Calibration of such virtual test methodologies involve a determination of acceptable congruence of virtual test results (generally embodied or quantified by one or more robustness scores) with the physical testing targeted for emulation. In this context, the objective of calibration is generally to quantify the value of virtual test results to predict, or reliably correspond to, physical test results. The calibration exercise in various embodiments of the present invention can be accomplished by executing a sample set of physical tests and then comparing the results of the physical tests to the virtual test results. Generally understood, calibration is achieved when the statistical characteristics of virtual testing results are substantially equal to the statistical characteristics of physical testing results within a calibration confidence range. The calibration exercise as practiced in certain embodiments of the present invention may naturally lend itself to automation efficiencies. Once a physical test dataset of statistically sufficient sample size is available, virtual test parameters can be automatically incremented until the results of the virtual test substantially match the results of the physical test. However, test personnel must be vigilant in considering abnormal artifacts in testing results that could invalidate calibration, and therefore, the wholesale automation of testing and approval processes to the extent that it bypasses human oversight (in whole or in part) must be carefully evaluated prior to implementation.

Functional safety is generally focused on preventing injury to persons, preserving financial resources, and limiting any environmental impact. The virtual testing employed by embodiments of the invention are analogous to established testing of hardware components in various environments where the safety thresholds for particular hardware components are generally characterized in terms of failure rate. In this context, the failure rate is used to estimate the Probability of Failure on Demand (PFD) or Probability of Dangerous Failure per Hour (PFH). This results in the satisfaction of functional safety requirements for Safety Integrity Level (SIL) and the variables of this calculation are determined by the results of virtual testing of the software. Virtual testing can be described in relation to the nature of the adversarial tests to which the software is exposed to determine how the software performs or fails to perform in certain circumstances. In the context of the present invention, safety systems can generally be described as having three layers: a perception layer, a behavioral layer, and a control layer. The perception layer involves the system ability to perceive its environment, and especially the aspects of the environment that can affect the decision-making process, and can include visual perception, motor feedback, sensor inputs, temperature, etc. The behavioral layer includes those aspects of the system that relate to the decisions that machinery decides to make based on programmed logic and relevant system inputs. The control layer is generally understood to be the traditional engineering aspects of motor control, power requirements, etc. that relate to the control of the machinery being controlled by the software. When the software, or safety model, is sent for testing, it will generally include the datasets relevant to the safety application. In the perception layer, those datasets could include any format of sense data (e.g., images or point clouds). In the behavioral level, the datasets might include relative and predictive motion data (e.g., if a human were to enter the safety zone, what path is the human likely to take through the zone). Finally, in the control layer, the dataset would include the relative ranges of control inputs and outputs that the model would be subjected to in the relevant environment.

For example, in one scenario, virtual testing in the perception layer emulates the real world environment while the software is evaluated by acting on the dataset of images submitted by the party seeking certification for a particular application. The initial virtual testing parameters may be based on a controlled environment in which the software is tested for its accuracy in properly identifying human actors in a dangerous situation. Further progressive software testing may introduce virtual adversarial tests such as ambient light, temperature, or sound pollution conditions into the testing environment to determine safety compliance under increasingly challenging conditions and rate the software according to a robustness score scale. Adversarial tests are tailored to assess the stress on the system using inputs that the system or machine will be receiving during operation. Inputs can be sensors, cameras, accelerometers, etc. that make up the overall perception of the relevant environment.

Adversarial tests in the behavioral layer are generally directed at whether the decisions made by the system are correct in view of the environmental data being perceived by the system from the other layers (perception and control). Such tests are generally focused on the decisions the system, robot, or machine makes assuming the environmental conditions and inputs are being appropriately measured and perceived. For example, if a welding robot needs to take action to prevent its arm from striking a person who has entered into its reach zone, adversarial tests are focused on determining whether the decision is appropriate under the circumstances (e.g., path prediction, collision avoidance, safe state selection).

An example of adversarial tests in the control layer could be a robot that needs to measure its orientation in relation to its environment using motor feedback (power, amperage, voltage). If the robot's assessment of its orientation is based on data from these control components then adversarial tests can be designed to exert electromagnetic interference (EMI) onto those inputs to apply stress to the control layer in order to determine the EMI level that will interfere with the robot's orientation measurement to such an extent as to cause system failure, or at least failure beyond established safety thresholds.

Embodiments of the claimed invention focus on the metrics that can be quantified such as true positives (corresponding to correctly detected samples), false positives (corresponding to detected samples that should not have been detected), true negatives (corresponding to correctly undetected samples), and false negatives (corresponding to undetected samples that should have been detected). Such metric categories, along with others that may be selected based on the application, form the basis of virtual testing methods that are utilized to set safety thresholds that correlate to the standard safety thresholds that software must pass during the physical testing required for safety certification. Assuming a consistent use environment, once the software has been initially certified, the certification process may no longer require physical testing for new software versions as long as the software maintains or exceeds the correlated metric levels present in the initial certification, which is generally referred to as robustness in the context of virtual testing.

Robustness score calculation may be assessed for the software's performance against adversarial attacks that are determined by a particular adversarial attack methodology. In the context of image recognition functionality, for example, an adversarial attack on an image is an effect applied to the image that represents an adversarial condition, which is an event that perturbs normal environmental conditions and potentially presents scenarios hazardous to humans or equipment. Robustness score calculations may be a function of true positives, false positives, true negatives, false negatives, failure frequency, rate of exposure, etc. Initial testing review will usually be performed by a test engineer. In the case of a failing robustness score, the executed test procedure may be reviewed for conformance to the prescribed test plan, calibration records will be reviewed, and reported results of all tests conducted will be reviewed. If the review reveals any deviations from the prescribed test plan, calibration, or reporting, the results may be invalidated and the test procedure repeated once appropriate corrective action has been implemented. Should a failing result for a particular test be confirmed, the test engineer may conduct an impact analysis of the results as they pertain to the safety function requirements and system capabilities. If the test engineer determines that the results meet the intent of the functional safety requirements even with a failing robustness score, the test engineer may submit the test results to a certification authority with an explanation of why the software warrants a departure from compliance with the robustness score schedule.

In the initial stages of testing parameter development, there will usually be a determination of a satisfactory robustness score for a particular software model that has been submitted for testing. This determination will result from a risk assessment presented by the activity being performed in conjunction with the relevant environmental conditions. For example, when performing a risk assessment of a robot arm that is operating in the proximity of human beings, the assessment may have the objective of preventing human beings from being hit by the robot arm and causing injury. After determining that injury to human beings constitutes an unacceptable risk, the requirements of the software will generally be to detect the presence of a human being, at which point the robot takes some action (to prevent injury) within a period of time (i.e., Safety Response Time). Depending on how unacceptable the risk is, a Safety Target or Safety Goal will usually be expressed in terms of Safety Integrity Levels (SIL), which corresponds to various levels of risk reduction. For a particular SIL, there will be a joint Probability of Failure on Demand (PFD) (i.e., system has failed to detect the human presence and the hazard - or human presence-has presented itself). Such a Failure on Demand in this robotics application example can also be expressed in terms of Probability of Dangerous Failures per Hour (PFH).

Carrying forward with the above example, image datasets of the environment where the robot will be operating and tasked with detecting a human presence will normally be supplied by the party seeking safety certification or approval. In the virtual test setting, the range of adversarial tests that can be applied during virtual testing is almost limitless compared to the constraints of physical testing. For example, in order to incrementally expose image datasets with the equivalent of increased ambient light brightness, pixel values can be adjusted on a pixel-by-pixel basis until the system no longer senses a human presence. In this context, the percentage value of the image that needs to be changed measures the robustness of the software to encounter and respond to adverse conditions. For example, if the image can be subjected to adversarial tests to the extent that 90% of the image has been changed, but the system can still detect a human presence, the system would be considered reasonably robust. On the other hand, if the image is exposed to adversarial tests to the extent that only 10% of the image has been changed, but the system fails to detect a human presence, then the system would be considered reasonably brittle. Of course, there are myriad of conditions that could affect whether the model being tested correctly detects the presence of a human being (e.g., ambient temperatures affecting camera functionality, repeating visual patterns in the background, non-human motion in the visual field). When describing various embodiments of the invention in visual terms, it is to be expressly understood that what the model “sees” is not limited to visual inputs, but rather to all inputs that effectively make up how the model may perceive a foreign object in the safety zone, whether those inputs fall into the perception, the behavioral, or the control level.

Prior to the initial virtual testing, a robustness level will initially be selected that corresponds to a passing physical test in the expected adversarial environment. Testing congruence refers to the general alignment of virtual test results with physical test results as the virtual testing process at base level seeks to emulate physical testing. However, once the initial threshold has been satisfied (e.g., software has passed virtual and physical testing), virtual testing thresholds would be expected to become more robust over time, though with results that remain congruent to physical test results. In this context, congruence is qualitatively measured in terms of calibration.

Another example of an embodiment of the present invention would be a software model that relates to a mobile robot whose safety objective is to avoid contact with human beings. The robot's perception of a human being within the robot's range of contact may comprise inputs from a camera, light sensors, radar, capacitors, etc. After the perception layer concludes that an object is a human being, the behavioral level determines what action should be taken to achieve the objective (i.e., avoid contact with human beings) based on an analysis of the perception data, which may be used to determine, for example, the likely path the human being is taking compared to the robot's route, which in turn will determine whether an unwanted collision is likely based on the inputs. In this context, adversarial attacks can focus on assessing the robot's collision-avoidance behavior if the robot's perception of the situation is inaccurate to some degree (e.g., the assessment of current position. orientation, and/or direction is inaccurate).

Upon satisfying the requirements of the virtual testing in an initial certification scenario, the software will then be subject to a physical test of the realized system. The physical test will be limited to the operational environment of the software itself (e.g., confirmation of software operational characteristics outside of the virtual environment, but without the need to test the hardware components controlled by the software). In one preferred embodiment of the invention, after the virtual testing and the physical testing procedures have been completed, a test report will be produced that indicates whether or not the software complies with the requirements of the applicable safety standard. If the software is determined to comply with both the virtual tests and the physical tests, the virtual test results and the associated robustness scores may be designated as congruent with the physical test results for the particular application, thereby setting forth a virtual testing threshold that corresponds to physical test compliance, which can later be used in a recertification process embodied in various embodiments of the claimed invention. The test report can then be provided to a certification authority, which determines whether the proper testing procedures were followed and analyzes the test data embodied by the test report. If the software (or software revision, as the case may be) is compliant with the applicable performance requirements, the certification authority certifies the software for the requested use in the appliable environment, and that certification is automatically sent to the original requester, which is then authorized to implement the software in the relevant application.

In situations in which the software has already been certified and the new certification request relates to a software revision, the process can be greatly expedited because safety and testing concepts and data can be reused (or reused with minimal revision) to certify new software version as they are uploaded to the testing/certification cloud as long as the fundamental use environment and associated hardware remain consistent.

Whether the software sought to be certified is original software requiring complete testing or is a revision of certified software, the certification time cycle may be significantly reduced while the safety testing methodology results in more reliable data for software safety assessments. The testing, inspection, and certification (TIC) process that incorporates various embodiments of the present invention should reduce the time from certification request to approval and improve applicable safety functionality so that safety can be improved along with performance in a timely manner that harnesses the power of ML and AI technologies, for example.

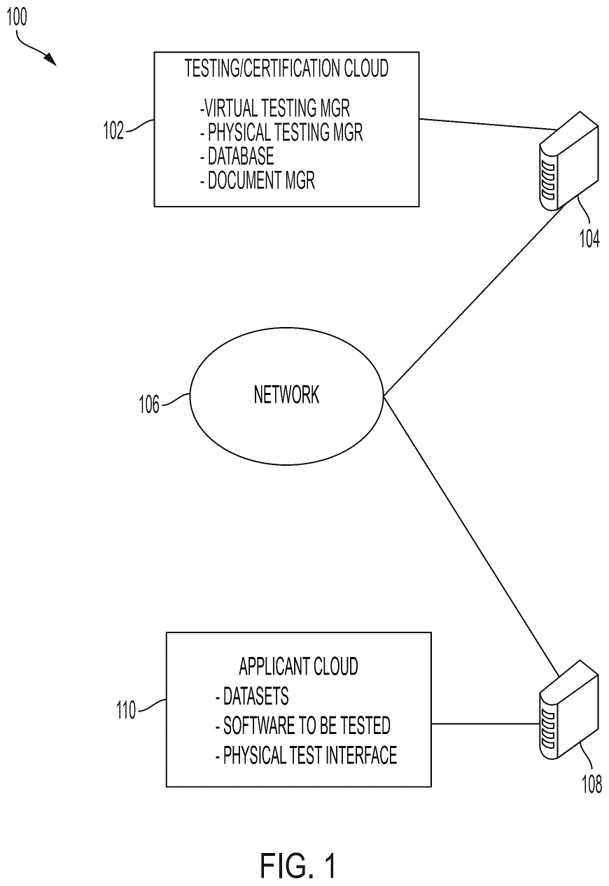

FIG. 1 shows a system configured according to embodiments of the present invention to test, certify, and recertify software for use in applications and environments subject to safety regulations. In operations according to embodiments of system 100, testing certification cloud comprises a virtual testing manager, a physical testing manager, a database, and a document manager, among other applications running on testing/certification system 104 which interacts with certification applicants through a website (e. g,, SaaS) or other interface accessible via network 106. As shown in FIG. 1, some embodiments of the invention may utilize applicant system 108 that interfaces with the testing/certification system 104 through coordinated applicant cloud 110, which may contain image datasets, the software to be tested, and physical test interfaces that are sent to or otherwise interacts with testing certification system 104 to facilitate testing and certification steps of the claimed methods. Testing/certification system 104 and applicant system 108 comprises one or more processors (e.g., a Grace, Orin, or Thor processer available from Nvidia Corporation) and requisite processor readable (e.g., computer readable) memory (e.g., random access memory, read only memory, flash memory, disk memory, solid state drive memory, optical memory, etc.) and input/output components (e.g., display, network interface card, keyboard, digital pointer, printer, etc.) coupled to a processor of one or more processors via a data bus. Testing/certification system 104 and applicant system 108 may be implemented as a single system, such as a single server, or as a distributed system (e.g., server farm), a number of host systems distributed remotely with respect to each other, etc. Each of systems 104 and 108 may also be integrated with one or more other systems providing the functionality detailed herein.

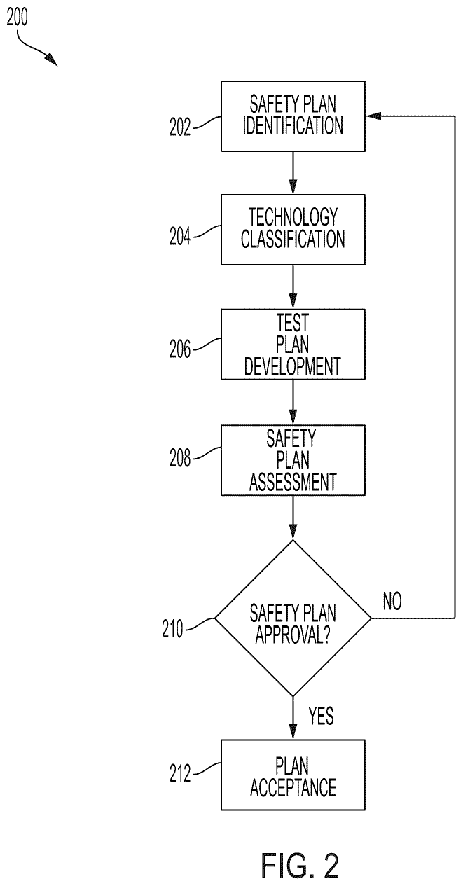

FIG. 2 shows the concept generation workflow of an embodiment of the present invention. Concept workflow 200 is broken down into component parts, beginning with the identification of safety plan 202 and technology classification 204 that may result in the development of a classification report. Safety plan 202 defines the relevant work environment and may include definitions for safe states, potential hazardous situations, external mitigating measures, system function, and risk reduction measures to be implemented. After classification step 104 has been completed, testing plan development step 206 includes the creation of a virtual test plan and a physical test plan. A realization plan that generally sets forth the overall project parameters and may identify the affected systems and/or subsystems, anticipated design elements, specifications, testing functionality, and objectives may also be generated. Virtual test plans generally set forth the virtual software testing use environment and may include the scope and nature of adversarial attacks, any dataset requirements, expected results, and pass/fail criteria. Physical test plans generally set forth the physical software testing use environment and may include the scope and nature of physical adversarial tests, test equipment, calibration information, expected results, and pass/fail criteria. Safety assessment step 208 is primarily an evaluation of the virtual test plans and physical test plans to ensure compliance with minimal, accepted, or aspirational safety standards. The result of safety assessment step 208 is approval step 210, which results in plan acceptance 212 or in plan rejection (concept workflow 200 can begin again or project reassessment steps may be implemented).

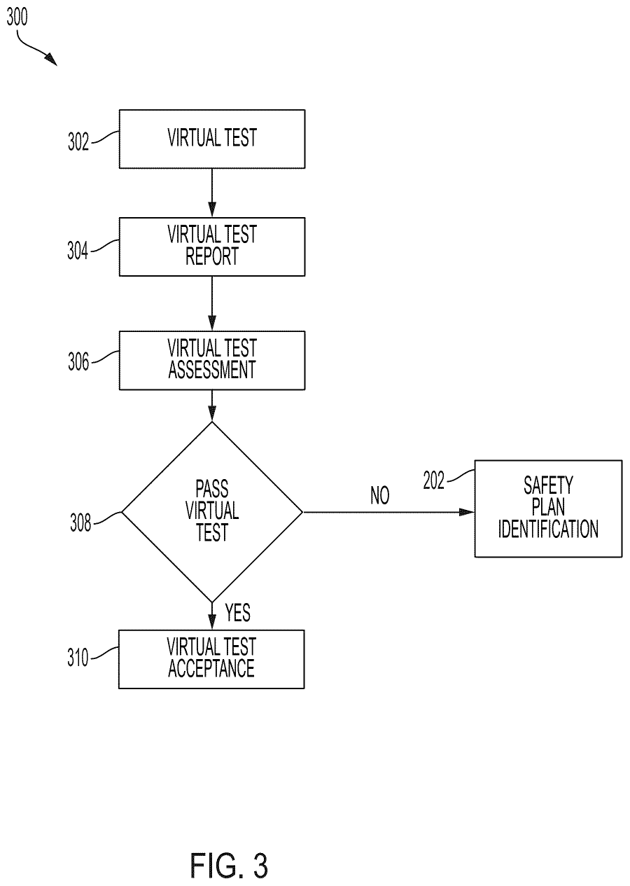

FIG. 3 shows the virtual testing workflow of an embodiment of the present invention. If plan acceptance 212 is approved, virtual test workflow 300 begins at virtual test 302, which comprises the execution of the virtual testing procedures set forth in the approved virtual test plan. Virtual test 302 will generally result in the creation of virtual test report 304 (e.g., electronic, hard copy, data populating a realization report, etc.), which sets forth testing criteria and results for each test performed. Virtual test report 304 may include test details, date of test execution, identification of test engineer who performed the virtual test, calculations, images, supporting evidence, and any modification, calibration, variance, or other relevant issues or information encountered or recorded during virtual test 302. Virtual test 302 may also result in the creation or revision to a realization report, which can be used to memorialize aspects of virtual test 302 as they relate to overall project parameters, including whether virtual test thresholds were satisfied during virtual test 302. Virtual test assessment 306 will lead to a passing or failing safety grade at step 308. If passing, virtual test acceptance 310 may be embodied in a physical document to be approved by physical signatory for record-keeping purposes or may be a non-transitory electronic document with corresponding electronic signature depending on the approval structure required and the document retention policies or statutory requirements governing the certification process. If a failing grade is assessed during virtual test assessment 306, then concept workflow 200 can begin again or project reassessment steps may be implemented.

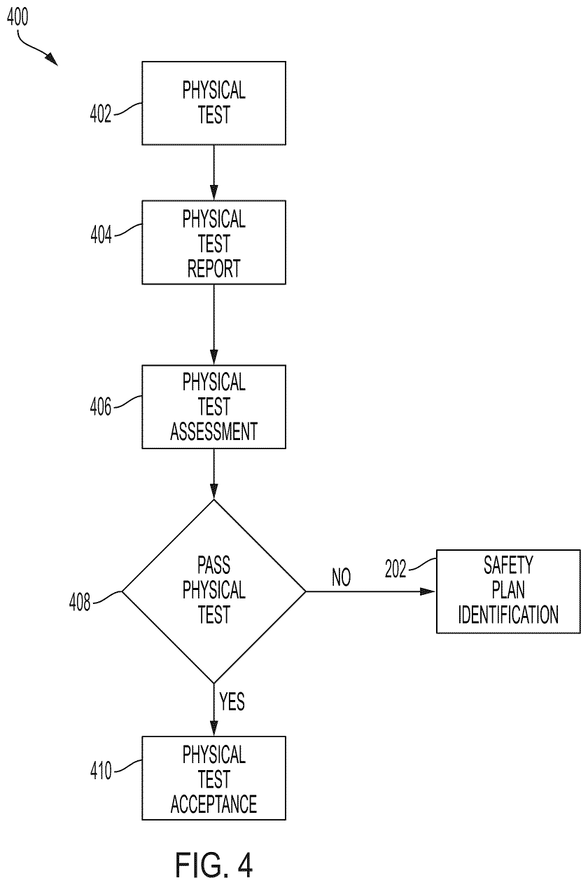

FIG. 4 shows the physical testing workflow of an embodiment of the present invention. If virtual test acceptance 310 occurs, physical test workflow 400 begins at physical test 402, which comprises the execution of the physical testing procedures set forth in the approved physical test plan. Physical test 402 will generally result in the creation of physical test report 404, which sets forth testing criteria and results for each test performed. Physical test report 404 may include test details, date of test execution, identification of test engineer who performed the physical test, calculations, images, supporting evidence, and any modification, calibration, variance, or other relevant issues or information encountered during physical test 402. Physical test 402 may also result in the creation or revision to a realization report, which can be used to memorialize aspects of physical test 402 as they relate to overall project parameters, including whether physical test thresholds were satisfied during physical test 402. Physical test assessment 406 will lead to a passing or failing safety grade at step 408. If passing, physical test acceptance 410 may be embodied in a physical document to be approved by physical signatory for record-keeping purposes or may be a non-transitory electronic document with corresponding electronic signature depending on the approval structure required and the document retention policies or statutory requirements governing the certification process. If a failing grade is assessed during physical test assessment 406, then concept workflow 200 can begin again or project reassessment steps may be implemented.

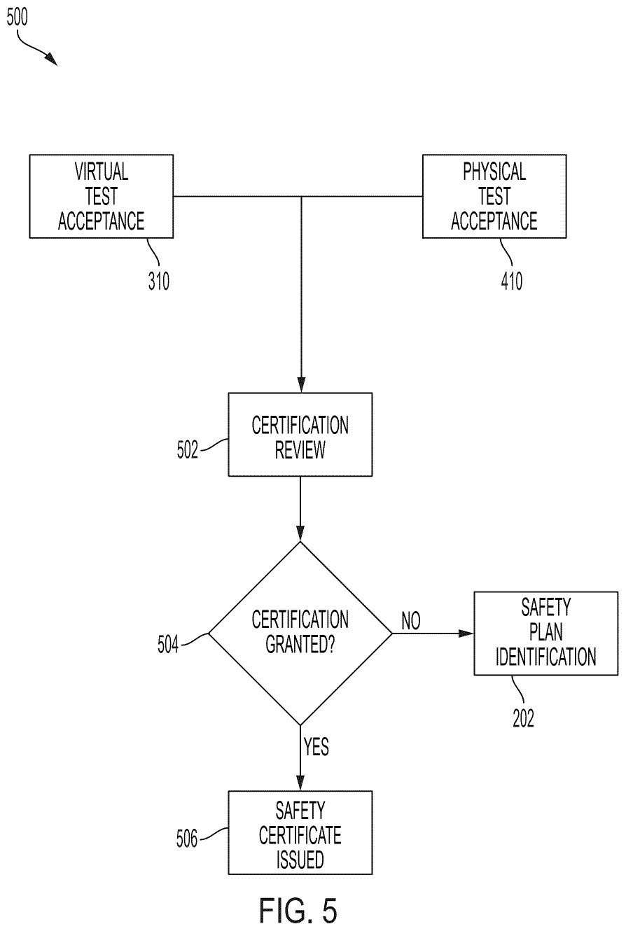

FIG. 5 shows final certification workflow 500 of an embodiment of the present invention. In the case of virtual test acceptance 310 and physical test acceptance 410, certification review 502 will begin. If certification review 502, which can be performed by the testing/certification entity or by a separate safety certification authority, results in approval at certification decision step 504, safety certification issuance step 506 will result in the certification of the safety model sought to be certified and may result in whatever documentation is required by any relevant safety regulations or guideline requirements. If a certification is denied for any reason, then concept workflow 200 can begin again or project reassessment steps may be implemented. Although the specification explains embodiments of the present invention in terms of certification, the present invention expressly includes approval mechanisms not limited to any particular formal certification process or constituent elements.

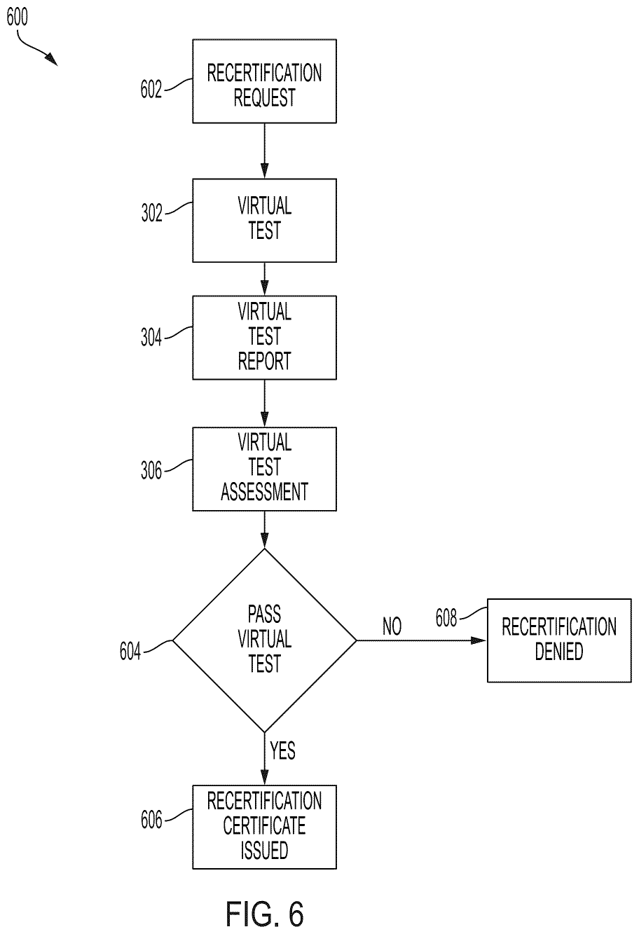

FIG. 6 shows recertification workflow 600 of an embodiment of the present invention. In cases of a recertification request for software that has undergone a revision, concept development, virtual test development, and physical test development are rendered unnecessary as long as the use environment and testing parameters have not changed since the certification immediately preceding the software upgrade/revision. Recertification of previously-certified software can begin with recertification request 602, which can be formal, informal, or something that automatically triggers the recertification process. Any testing setup activities should also be minimal as the testing has already been performed and the previous version of the software passed. For example, absent dataset modifications (which may not be allowed in recertification), the same datasets will be applicable and should already be stored and ready for testing in the testing/certification cloud. Any problems, aberrations, revisions, changes, etc. that were implemented or encountered in the previous certification process would have been corrected or overcome in order for the previous certificate to have issued, so virtual and physical testing methodology and assessment parameters will require no alteration (and may not be subject to alteration during recertification). The recertification time horizon can be greatly compressed and can be triggered automatically with the proposed issuance of any new software version. The recertification process of embodiments of the present invention begins with recertification request 602, followed by virtual testing 302, the creation of a virtual test report 304, and virtual test assessment 306. Virtual Test assessment 306 will lead to a passing or failing safety grade at step 604, which will result in the issuance of a recertification certificate at step 606 if software passes virtual test 302. If the software fails virtual test 302, recertification will be denied at step 608. Delays caused by plan and test development will naturally be avoided in the recertification process. More importantly, the physical testing component of the initial certification process can be avoided at recertification because that initial certification will result in “passing” virtual test metrics that correlate to “passing” physical test standards. Therefore, if the software passes the virtual test during the recertification process, there will be no need to conduct the physical test, greatly reducing the certification cycle by eliminating the physical test flow entirely. And as the virtual test methodology and assessment are largely computerized and can be performed using robustness score grading of the software to be recertified, the extent to which human review of the process is necessary will be largely determined by the comfort level of certification authorities, safety regulators, or government entities.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for certifying a safety model wherein virtual test results and physical test results are correlated to enable the certification of a new version of said safety model by using only virtual testing comprising:
a hardware processor that is configured to accept a request to approve said safety model for use in said environment requiring safety compliance approval, virtually test said safety model using adversarial attacks configured to emulate said environment requiring safety compliance approval, physically test said safety model for compliance with safety standards, and analyze test results to determine whether said safety model should be approved for use in said environment requiring safety compliance approval;
a memory connected to said hardware processor, said memory configured to store safety test protocols, test results, certification histories, and safety certificates; and
a database within said memory wherein safety model datasets, tested safety model, and test correlation data are maintained.

2. The system for certifying a safety model of claim 1 wherein said hardware processor is further configured to issue a safety certificate.

3. The system for certifying a safety model of claim 1 wherein said hardware processor is further configured to send said test results to a certification authority.
The system for certifying a safety model of claim 3 wherein said hardware processor is further configured to receive a safety certificate from said certification authority.

5. A method for approving a safety model for use in an environment requiring safety compliance wherein the results of a set of virtual tests and a set of physical tests to which said safety model is subjected are correlated so that future versions of said safety model can be approved by passing said set of virtual tests comprising:
accepting a request to approve said safety model for use in said environment requiring safety compliance approval;
virtually testing said safety model using adversarial attacks configured to emulate said environment requiring safety compliance approval;
physically testing said safety model for compliance with safety standards; and
analyzing test results to determine whether said safety model should be approved for use in said environment requiring safety compliance approval.

6. The method for approving a safety model of claim 5 further comprising correlating virtual test results with physical test results.

7. The method for approving a safety model of claim 5 further comprising issuing a safety certificate.

8. The method for approving a safety model of claim 5 further comprising sending said test results to a certification authority.

9. The method for approving a safety model of claim 8 further comprising receiving authorization from said certification authority to issue a safety certificate.

10. The method for approving a safety model of claim 8 further comprising receiving a safety certificate from said certification authority.

11. A method for recertifying a safety model wherein a previous version of said safety model was certified as safety compliant by passing a set of virtual tests and a set of physical tests and wherein recertification of said safety model is based on meeting or exceeding said set of virtual tests comprising:
accepting a request to recertify said safety model;
virtually testing said safety model using the virtual testing process used for said previous version of said safety model; and
analyzing virtual test results by comparing said virtual test results with virtual test results from the certification of said previous version of said safety model, wherein said virtual test results from the certification of said previous version of said safety model are calibrated to physical test results from said certification of said previous version of said safety model.

12. The method for recertifying a safety model of claim 11 further comprising certifying said safety model if virtual test results meet or exceed said virtual test results from said certification of said previous version of said safety model.

13. The method for recertifying a safety model of claim 11 further comprising issuing a safety certificate authorizing recertification of said safety model.

14. The method for recertifying a safety model of claim 11 further comprising sending said virtual test results to a certification authority.

15. The method for recertifying a safety model of claim 11 further comprising sending virtual test analysis to a certification authority.

16. The method for recertifying a safety model of claim 15 further comprising receiving authorization from said certification authority to issue a safety certificate.

17. The method for recertifying a safety model of claim 15 further comprising receiving a safety certificate authorizing recertification of said safety model.

18. The method for recertifying a safety model of claim 17 further comprising storing said safety certificate.

19. The method for recertifying a safety model of claim 11 wherein said virtual test results become the basis for analyzing virtual test results for a subsequent recertification.

20. The method for recertifying a safety model of claim 19 wherein said subsequent recertification does not require physical testing of said safety model.
